(19) United States
(12) Patent Application Publication
(10) Pub. No.: US 2001/0047278 A1
(43) Pub. Date: Nov. 29, 2001

(54) Dynamic reassignment of postal metering device licensing location

(76) Inventors: George M. Brookner, Norwalk, CT (US); Michael R. Landino, Orange, CT (US)

Correspondence Address: PERMAN & GREEN, 425 POST ROAD, FAIRFIELD, CT, 06430, US

(21) Appl. No.: 09/829,171

(22) Filed: Apr. 9, 2001

Related U.S. Application Data
(60) Provisional application No. 60/195,683, filed on Apr. 7, 2000.

(51) Int. Cl. G06F 17/60

(52) U.S. Cl. 705/1; 705/64

(57) ABSTRACT

A method for operating a device, a device, and an arrangement including the device, for the secure storage of funds comprising interfacing the device with a system; transmitting from the device to the system a present location of the device; comparing in a database associated with the system the present location of the device with a previously stored location; and transmitting to the device from the system an authorization to utilize the funds only if the present location is within a predetermined region associated with the previously stored location. The authorization is transmitted only if the present location matches the previously stored location. Generally, the device is licensed for use at the previously stored location, and if the comparing indicates that the device is not in the predetermined region, the system issues a new license for a region associated with the present location of the device.

This application claims priority under 35 U.S.C. §119(e) from provisional patent application Ser. No. 60/195,683 filed on Apr. 7, 2000, which is incorporated herein by reference.

### BACKGROUND OF THE INVENTION

1. Field of the Invention

The present invention relates to postal metering devices. More particularly it relates to the reassignment of the location of postal metering devices, and the apparatus therein used to securely store funds.

2. Background Art

Throughout the history of postage metering, at least in the United States, it has been a requirement of the Postal Service to assure the postage funds spent from a postage meter were allocated to the post office where the meter is registered.

In accordance with United States Postal Service (USPS) regulations, a postage meter licensee must obtain a meter license from the post office where the mailing is to be deposited. If a licensee changes the post office where metered mail is to be deposited, the meter must be checked out of service by the licensing post office. That meter or another meter must be licensed at the new post office before it is reset or initial settings are made. This is a marked disadvantage in terms of the lack of flexibility and inconvenience to the user.

The purpose of the above, historic, method of meter licensing is to assure that the proper local post office is credited with the postage dispensed by its licensed meters. With the advent of smaller and smaller postage metering device and in fact transportable postage funds vaults, these present day licensing techniques and their inherent disadvantages are no longer necessary.

### SUMMARY OF THE INVENTION

It is an object of this invention to provide a postage funds vault (also referred to as a Postal Security Device (PSD), herein) able to be moved from location-to-location and used to dispense postage in all locations, while the proof of postage expenditures are allocated to the local post office where the mailpiece will be deposited.

It is another object of this invention to change the post office licensing location used by the PSD to accommodate the use of said PSD at locations other than the initial licensing post office.

It is still another object of this invention to provide the ability to dynamically identify the location of the PSD at the time of use to an appropriate infrastructure such that the related local post office locations may be programmed into the PSD. The infrastructure of choice may be the existing infrastructure referred to as Telemetering Setting (TMS) generally in service today (also referred to as Computerized Remote Postage meter Resetting System (CMRS)). Other infrastructure implementations are envisioned, including that of the USPS. These CMRS entities allow remote funds loading into the PSD.

It is yet another object of this invention to adapt a PSD to a printing system such that the PSD-printer combination may be moved from location to location. This is typical of a small postal metering device of this type.

In accordance with the invention, the TMS, at all times knows the physical location of any PSD that is dispensing postage. The TMS will immediately notify the local USPS infrastructure that the license holder of any specific PSD is using said PSD in a location outside that to which it was originally licensed. For example, the PSD may have been licensed to the home address of the customer, and the customer may then use the PSD at some other location outside the servicing area of the local post office that assigned the license. Preferably, the TMS notifies a centralized USPS infrastructure as to its whereabouts, and the centralized postal infrastructure associates the PSD location to the appropriate local post office.

The USPS infrastructure then issues a modified meter license reflecting the location of the PSD to the TMS center. The associated TMS database acknowledges to the associated PSD that its postal zip code is changed, or that, in addition, its city/state location is changed. The PSD then receives a download with the related zip code and/or city/state designation. Then the PSD produces proof of postage indicium with the correct local postal drop off location.

Thus, the invention is directed to a method for operating a device for the secure storage of funds comprising interfacing the device with a system; transmitting from the device to the system a present location of the device; comparing in a database associated with the system the present location of the device with a previously stored location; and transmitting to the device from the system an authorization to utilize the funds only if the present location is within a predetermined region associated with the previously stored location. The authorization is transmitted only if the present location matches the previously stored location. Generally, the device is licensed for use at the previously stored location, and if the comparing indicates that the device is not in the predetermined region, the system issues a new license for a region associated with the present location of the device.

The method may further comprise communicating from the system to the device, data associated with the present location.

The device may be a postal security device and the data may include at least one of zip code, city and state information. The method may further comprise powering up the device, the method being conducted when the device is powered up. Generally the transmitting is done when the device establishes a contact with the system. The contact with the system may be terminated after the location of the device is determined.

If the contact is made by telephone, the location of the device is determined by using caller identification. If the contact is made using a network, the location of the device is determined by obtaining a network address of the device. If the contact is made using the internet, the location of the device is determined by using internet service provider location identification. If the contact is made using a cellular telephone port, the location of the device is determined using a location identifier of a cellular telephone system with which the cellular telephone communicates. The device may be associated with a position determining apparatus for determining its location, the device providing to the system its location as determined by the position determining apparatus. The position locating apparatus may be a global positioning system receiver.

Also in accordance with the invention, there is provided a device for the secure storage of funds comprising a memory for storing value of the funds; apparatus associated with the device for determining a location of the device; and a communication port for providing communication between the device and a system, the device communicating the location to the system via the port. The device may further comprise apparatus for receiving from the system an authorization to access the funds, if the location is within a predetermined region, or alternatively, if the location corresponds to a predetermined location.

The invention is also directed to an arrangement for securely dispensing funds comprising a device for the secure storage of funds, including a memory for storing value of the funds, apparatus associated with the device for determining a location of the device; a communication port for providing communication between the device and a system, the device communicating the location to said system via said port; the system having a database for storing, for each device, a predetermined location; and apparatus in the system for providing an authorization to the device to dispense funds only if the present location is within a region associated with the predetermined location, or if the present location is the predetermined location. Preferably, cryptographic key management supports secure communication with the device. The device may include apparatus for inhibiting operation of the device or the host, if the device does not receive a predetermined digital coded sequence from the host or the host does not receive a predetermined digital coded sequence from said device.

### BRIEF DESCRIPTION OF THE DRAWINGS

The foregoing aspects and other features of the present invention are explained in the following description, taken in connection with the accompanying drawings, wherein:

FIG. 1 is a conceptual representation of a PSD in accordance with the invention.

FIG. 2 is a system diagram illustrating the manner in which different types of PSD's in accordance with the invention may be interfaced in the system.

### DETAILED DESCRIPTION OF THE PREFERRED EMBODIMENT

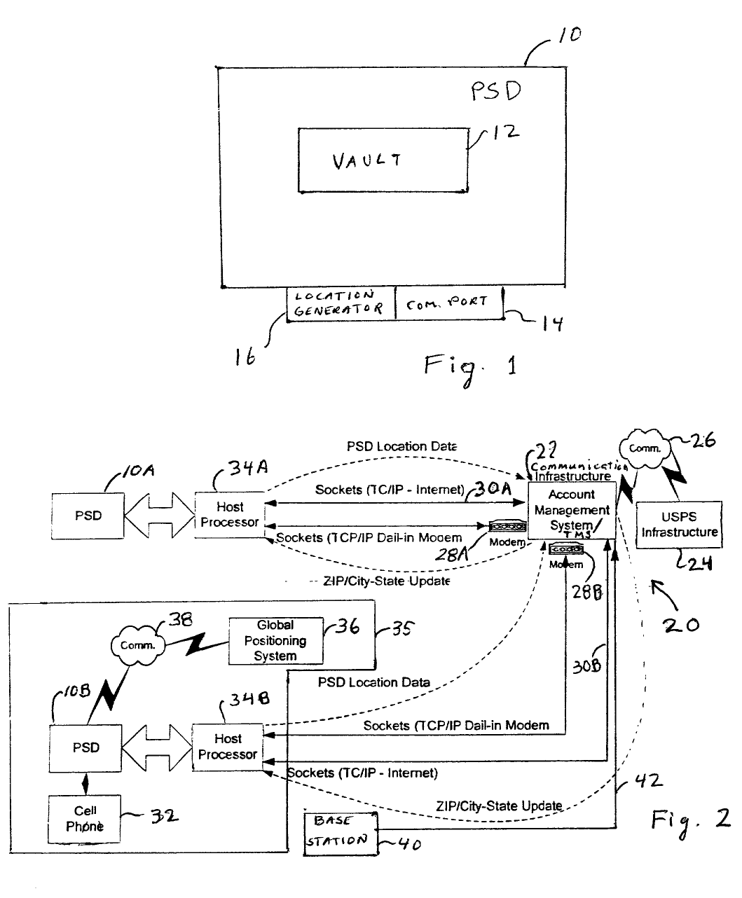

Referring to FIG. 1, a secure source of funds such as a PSD 10 is configured with a well known vault structure 12 which generally includes an ascending register, a descending register and suitable encryption technology to allow it to receive funds from a central telemetering system and to dispense those funds for use in, for example, a standard postal metering system. Vault 12 is also associated with a communications port 14 to allow the downloading of funds from the telemetering system and the withdrawal of funds by the postal metering system.

The PSD 10 according to the invention is also associated with a location generator 16 which derives information concerning the location of the PSD. This can be accomplished in a variety of ways as more fully described below with respect to FIG. 2. However, what is important is that when PSD 10 makes contact with the central TMS system, it transmits, by way of the communications port 14, the location information generated by location generator 16, to the central system. Preferably, this is done whenever the PSD 10 is powered up. While it could be done more frequently, or even on a continuous basis, this would be a wasteful use of communication resources.

After receiving the location, the central system either permits PSD 10 to dispense postage if it is at its licensed location (or in a region associated with the licensed location, such as within the same zip code area) or, as more fully described below, inhibits the dispensing of postage until a new license is issued for the new location. Once the central TMS system has received the new location of the PSD 10 it is no longer necessary to maintain a connection with it. The connection may be broken until the next time PSD 10 is powered up. It will be recognized by one skilled in the art that this required communication with the telemetering system may be used as an opportunity to download funds, transmit logs, or deal with other administrative chores generally associated with communication between the PSD 10 and the central system. As is well known in the art such communication is generally conducted using appropriate encryption technology such as for example, public key, private key digital encryption to enhance security and may be digitally signed with an appropriate digital certificate.

Referring to FIG. 2, a system 20 in accordance with the invention is illustrated. A corporate/communication infrastructure (such as one operated by a particular corporation) or more simply a communications infrastructure 22, including appropriate TMS and account management systems, is connected through a communication link with the postal authority infrastructure, such as in the United States, the United States Postal Service infrastructure 24, by a secure communications link 26. Communications infrastructure 22 is in turn connected to numerous PSD's 10A, 10B. In accordance with the invention are various means for the PSD's to communicate with communications infrastructure 22. These include dial-in modems 28A, 28B, and internet connections 30A, 30B using secure sockets with the TC/IP internet protocol. Alternatively, a PSD may communicate with communications infrastructure 22 using a cell phone port 32.

Each PSD 10A, 10B according to the invention is generally associated with a host processor 34A or 34B. In the case of a postal metering system for a home or small business, host processor 34A may be in a small portable postal metering system. Alternatively, host processor 34A may be a personal computer. In any event, a connection between host processor 34A and communications infrastructure 22 is established by either dial-in modem 28A or using the internet as illustrated at 30A. Upon powering up of the PSD, PSD location data is transmitted from either PSD 10 via host processor 34A or from processor 34A to communications infrastructure 22. The most secure arrangement is to have the PSD generate the location information. Thus, any change in the location of the PSD will be detected. However, it is also possible to have the host processor generate location information, or to be associated with apparatus that performs this function. In this case, it is preferred that the PSD and its host are configured so that they can only operate if associated with one another. For example, the PSD may be configured so that it will operate only if it receives a predetermined digitally coded data sequence from the host processor with which it is intended to operate. In addition, or in the alternative, the host processor may be configured so that it will not withdraw funds from a PSD unless the PSD provides to it a different, predetermined digitally coded data sequence. The general approach here is to enhance security when the PSD may be removed from the postage metering device.

In the case of a dial-in modem, a determination of the location of the PSD may be accomplished by using ordinary caller identification, if an ordinary public service switched network telephone line is used. However, in this case the option of suppressing caller identification may not be used when the call to communications infrastructure 22 is made.

If the PSD location data transmitted from host processor 34A matches that stored in the database associated with the account management system of communications infrastructure 22, then communications infrastructure 22 transmits an authorization to the host processor to allow PSD 10A to dispense postage. As noted above, an opportunity now exists for ordinary exchanges between the PSD 10A and communications infrastructure 22 to take place such as downloading funds or uploading logs. After any such house keeping functions occur, which are not required in accordance with the invention, the connection between host processor 34A and communications infrastructure 22 may be broken.

If the PSD location data transmitted to communications infrastructure 22 does not match that stored in the account management system of communications infrastructure 22, the USPS infrastructure 24 is informed of this change via communications link 26. The USPS infrastructure then issues a modified meter license reflecting the location of the PSD 10A to the communications infrastructure 22. The account management system database is updated and the host processor 34A receives information indicating that the postal zip code and if appropriate to the new location, the city/state location has been changed. When this information has been downloaded to the host processor, the PSD can then produce proof of postage indicium with the correct local postal drop off location data contained therein.

In the case of larger postal metering systems, the PSD 10B may be associated with a host processor 34B in a rather large mailing system 35. Again, connections may be made using a dial-in modem 28B over a telephone line or via the internet 30B. In the case of an internet connection, the location of the host processor and therefore the PSD may be determined by using the internet service providers' user location information. The IP address of the host processor can pinpoint the location of the PSD. Again, the PSD location is uploaded to communications infrastructure 22 and if necessary, because the location has changed, zip code and city and state update information is downloaded to host processor 34B.

Another alternative way of obtaining location information is to have associated with the postal metering system a global positioning system receiver 36 connected through a communications link 38 to the PSD. Thus, accurate global positioning system information may be provided through the host processor 34B to communications infrastructure 22 to quickly and accurately identify the location of PSD 10B.

As yet another alternative, a cell phone port 32 may be associated with PSD 10B of the associated postal metering system. The cell phone may make contact, through an appropriate base station 40 and a telephone line 42, with communications infrastructure 22. The cell phone system would thus provide, via its location identifier, the location of the PSD.

While the present invention has particular applicability to the printing of postal indicia due to the postal regulations, it will be understood that it may be applied to a variety of applications. For example, items other than postal indicia may be printed. In this case, where there may be no specific regulations on point, the invention will provide an additional layer of security so that if the secure source of funds and its associated system are stolen and moved to a new location (besides the usual security measures such as call back requirements, where the communications infrastructure 22 returns a phone call to the host processor associated with the PSD) it will instantly become evident that the PSD has been moved.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for operating a device for the secure storage of funds comprising:
interfacing said device with a system;
transmitting from said device to the system a present location of said device;
comparing in a database associated with said system the present location of said device with a previously stored location; and
transmitting to said device from said system an authorization to utilize said funds only if the present location is within a predetermined region associated with said previously stored location.

2. The method of claim 1, wherein said authorization is transmitted only if the present location matches the previously stored location.

3. The method of claim 1, wherein said device is licensed for use at said previously stored location, and if the comparing indicates that the device is not in the predetermined region, the system issues a new license for a region associated with the present location of said device.

4. The method of claim 3, further comprising communicating from the system to the device, data associated with the present location.

5. The method of claim 4 wherein said device is a postal security device and said data includes at least one of zip code, city and state information.

6. The method of claim 1, further comprising powering up said device, the method being conducted when said device is powered up.

7. The method of claim 1, wherein said transmitting is done when said device establishes a contact with said system.

8. The method of claim 7, wherein said contact with said system is terminated after the location of said device is determined.

9. The method of claim 7 wherein if said contact is made by telephone, the location of said device is determined by using caller identification.

10. The method of claim 7 wherein if said contact is made using a network, the location of said device is determined by obtaining a network address of said device.

11. The method of claim 7 wherein if said contact is made using the internet, the location of said device is determined by using internet service provider location identification.

12. The method of claim 7 wherein if said contact is made using a cellular telephone port, the location of said device is determined using a location identifier of a cellular telephone system with which said cellular telephone communicates.

13. The method of claim 7 wherein said device is associated with a position determining apparatus for determining its location, said device providing to said system its location as determined by said position determining apparatus.

14. The method of claim 13 wherein said position locating apparatus is a global positioning system receiver.

15. The method of claim 1 wherein said device is a postal security device.

16. A device for the secure storage of funds comprising:
a memory for storing value of said funds;
apparatus associated with said device for determining a location of said device; and
a communication port for providing communication between said device and a system, said device communicating said location to said system via said port.

17. The device of claim 16 further comprising apparatus for receiving from said system an authorization to access said funds, if said location is within a predetermined region.

18. The device of claim 17 wherein said apparatus provides access to said funds if said location corresponds to a predetermined location.

19. The device of claim 16, further comprising apparatus for encrypting and digitally signing, or digitally signing said communication.

20. An arrangement for securely dispensing funds comprising:
a device for the secure storage of funds, including:
a memory for storing value of said funds,
apparatus associated with said device for determining a location of said device;
a communication port for providing communication between said device and a system, said device communicating said location to said system via said port;
the system having a database for storing, for each device, a predetermined location; and
apparatus in said system for providing an authorization to said device to dispense funds only if said present location is within a region associated with said predetermined location.

21. The arrangement of claim 20 wherein said apparatus provides said authorization only if said present location matches said previously stored location.

22. The arrangement of claim 19 wherein cryptographic key management supports secure communication with the device.

23. A device for the secure storage of funds comprising:
a memory for storing value of said funds;
a communication port for providing communication with a with a host for said device;
apparatus for preventing operation of said device or said host if said device does not receive a predetermined digital coded sequence from said host or said host does not receive a predetermined digital coded sequence from said device.
